(19) United States
(12) Patent Application Publication
(10) Pub. No.: US 2007/0167086 A1
(43) Pub. Date: Jul. 19, 2007

(54) Electronic Communication Devices and Methods

(76) Inventor: William D. Tolli, Leominster, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 11/538,924

(22) Filed: Oct. 5, 2006

Related U.S. Application Data
(60) Provisional application No. 60/723,669, filed on Oct. 5, 2005.

(51) Int. Cl. H01R 9/22

(52) U.S. Cl. 439/712

(57) ABSTRACT

Circuits, devices, systems and methods for transmitting power and communication signals are described. The invention can include a system for commanding and monitoring the status of a plurality of electrical devices and can include two or more communication modules. A primary communication module can be connected to a DC power source, and can transmit voltage signals over a single conductor, and one or more secondary communication modules can transmit current signals over the single conductor. The communication modules of the present invention can each include an interface for bi-directional communication, at least one MOSFET, an AUSART, and a microprocessor. The communication circuit of the present invention can be a bi-directional communication circuit and can include a connection to a single conductor, an encoder, a decoder, and a least one MOSFET. The present invention can also include a method for transmitting digital data messages and power, and can include monitoring and decoding voltage pulses transmitted from a first communication module and monitoring and decoding current pulses send from at least a second communication module, where the voltage pulses from the first communication module can be used to power at least the second communication module.

### CROSS-REFERENCE TO RELATED APPLICATION

This invention is based upon and claims the benefit of priority from U.S. Provisional Application Ser. No. 60/723,669 filed Oct. 5, 2005, the entire contents of which are incorporated by reference herein.

### FIELD OF THE INVENTION

This invention relates to circuits, devices, systems, and methods for the transmission of digital data messages and power over a single conductor to a plurality of electrical devices disposed throughout a machine, instrument, or appliance, or to any application where loads supplied by a DC power source require remote control, including but not limited to automotive, aeronautic, maritime, locomotive, and construction applications.

### BACKGROUND

Conductors are used to supply power from a battery or other power source to a load applied by an electrical device or system. Since each load requires two separate wires, one hot and one ground, and since an electrical device or system may have many loads, it is common for one electrical device or system to require numerous individual wires.

An example of such a system is a motorcycle. A typical motorcycle includes a battery, which is often placed towards the rear, near the engine, and at a minimum, a headlight, turning signals, and a horn, all located at the front. This configuration requires at least four wires running through or along the frame of the motorcycle between the front and rear: one hot connection for a switch, and one hot connection for each of the three loads, with the frame of the motorcycle used as ground. This collection of wires is often termed a wiring harness.

Current motorcycle designs are much more elaborate than the simple configuration previously described and may include a speedometer, a tachometer, additional lights, and even a digital dashboard. The result is a very complicated wiring harness running through or along the frame of the motorcycle between the front and rear. For example, the schematic for at least one popular modern motorcycle calls for over thirty wires running between the front and the rear. This additional complexity may result in a corresponding increase in installation time and a greater possibility of installation error. Thus, there is a need in the art to minimize the time required to install wiring systems and decrease the possibility of wiring errors.

In addition to these installation issues, a complex wiring harness may result in a heightened probability of failure, as there are more wires that may abrade against the frame or other metal components. Troubleshooting a complex wiring harness may also be difficult, and a professional motorcycle technician may spend many hours, and even days, identifying the problem source. Repair work may consequently be expensive. Less tangible, but no less important, the time a motorcycle spends in a mechanic's shop often equates to time not spent riding. In addition, the wiring may be so cumbersome and difficult to manage that relatively few people are confident enough to perform the required upkeep on the electrical system. As a result, wiring system maintenance and repair may be neglected, endangering riders' safety. Thus, there is a need in the art to minimize failure rates in wiring harnesses, and to reduce the time spent identifying the source of a failure. In addition, there is a need in the art to simplify wiring harness repair and maintenance.

A complex wiring harness may also detract from the motorcycle appearance. This is especially significant for high-end motorcycles where considerable emphasis is placed on external design. Thus, there is a need in the art for an unobtrusive wiring harness.

One method of reducing the number of wires running between the front and rear of a motorcycle is to utilize the frame of the motorcycle as the ground conductor. This technique, used in conventional harnesses, decreases the required number of wires by almost half. Even with this reduction, however, there are still many wires to install, troubleshoot, and maintain. For example, an experienced motorcycle technician may spend eight hours on average to install a conventional wire harness. Further, the vibration of the motorcycle often results in bad ground connections, damaged components, and increased maintenance.

One potential solution for making the wiring harness less obtrusive is to use smaller wires. Using higher gauge conductors reduces the overall thickness of the wiring harness, and helps to hide the wiring harness from view. Thinner, higher gauge wires, however, are less able to withstand currents normally present in motorcycle wiring, are more prone to damage due to wear and vibration, and are still susceptible to the problems described previously, including but not limited to lengthy installation times, difficulty in troubleshooting problems, and the potential for poor ground connections.

Multiple methods for simplifying troubleshooting problems have been implemented. For example, there are products that route wires to a central location where they can be tested and diagnosed with relative case. These devices label the incoming and outgoing wires by function to assist the user in identifying what maintenance to perform. Because it is easier to make sense of the wiring when it is labeled and all in one place, the user can test and diagnose problems such as continuity, short circuits and open circuits without having to rummage through dozens of wires and remember which wires serve which function. These products, however, do not reduce the number of wires used in the wire harness.

Another method of simplifying installation and troubleshooting is to use a color-coding scheme that allows for quick identification of a wire's function. However, these schemes can become quite complicated, using striped, dashed striping, and other techniques to distinguish the different conductors. To complicate matters, there is no unifying color standard for motorcycles. Many custom builders do not follow any color-coding and simply test each end of a wire after it has been run through the frame of the motorcycle.

One method of reducing wiring failures is to enclose the wiring harness in a loom or a sleeve. The loom itself, however, is still subject to wear, melting, and aging. Further, the loom or sleeve may actually complicate troubleshooting, because it may have to be removed to diagnose and repair the electrical system.

One further way of simplifying wiring harnesses is to replace standard devices such as circuit breakers and fuses with solid-state components. This technique is not often used, though, and usually adds significantly to the cost of a motorcycle.

The problems associated with complex wiring harnesses are not limited to motorcycles or even motorized vehicles and are common to any application where loads supplied by a DC power source require remote control, including but not limited to automotive (cars and trucks), aeronautic (planes and helicopters), maritime (power boats and motorized sailboats), locomotive (trains and trolleys), and construction (elevators and heating, ventilation and air-conditioning (HVAC)) applications.

The present invention alleviates or eliminates at least some of the disadvantages of the prior art. These and other advantages of the present invention will be apparent from the description set forth below.

### SUMMARY OF THE INVENTION

The present invention provides new and improved circuits, devices, systems, and methods for transmitting power and communication signals using a single conductor and a common ground point. The invention can include a system for commanding and monitoring the status of a plurality of electrical devices and can include two or more communication modules. A primary communication module can be connected to a DC power source, and can transmit voltage signals over the single conductor, and one or more secondary communication modules can transmit current signals over the single conductor. The communication modules of the present invention can each include an interface for bi-directional communication, at least one MOSFET, an AUSART, and a microprocessor. The communication circuit of the present invention can be a bi-directional communication circuit and can include a connection to a single conductor, an encoder, a decoder, and a least one MOSFET. The present invention can also include a method for transmitting digital data messages and power, and can include monitoring and decoding voltage pulses transmitted from a first communication module and monitoring and decoding current pulses send from at least a second communication module, where the voltage pulses from the first communication module can be used to power at least the second communication module.

### BRIEF DESCRIPTION OF THE DRAWINGS

Other objects, features and advantages will occur to those skilled in the art from the following description of the preferred embodiments and the accompanying drawings, in which:

FIG. 1 is a block diagram of a preferred embodiment of the single conductor communication system of the invention;

FIG. 2 is a block diagram of a preferred embodiment of the single conductor communication system shown in FIG. 1 as applied to a motorcycle;

FIG. 3 is a block diagram of a preferred embodiment of the rear control box of the single conductor communication system of the invention shown in FIG. 2;

FIG. 4 is a block diagram of a preferred embodiment of the front control box of the single conductor communication system of the invention shown in FIG. 2;

FIG. 5 is an exemplary schematic diagram of a preferred embodiment of the communication circuitry of the rear control box shown in FIG. 3;

FIG. 6 is an exemplary schematic diagram of a preferred embodiment of the communication circuitry of the front control box shown in FIG. 4;

FIG. 7 is a flow chart of the preferred embodiment of the half-duplex transmissions of the microprocessors shown in FIGS. 3 and 4; and

FIG. 8 is an exemplary graph of the voltage and current pulses transmitted over the single conductor from the perspective of the rear control box shown in FIG. 2.

### DETAILED DESCRIPTION OF THE PREFERRED EMBODIMENTS AND METHODS

The present invention relates to circuits, devices, systems, and methods for transmitting power and communication signals using a single conductor and a common ground point. As described in further detail below, the present invention incorporates embedded microprocessors and Metal Oxide Semiconductor Field Effect Transistor (MOSFET) circuit technology in a multiple-master controller system to control the transmission and reception of digital signals over a current-carrying wire.

The present invention is described below in terms of a wiring harness for a motorcycle, although it is understood that the invention is not limited to this application. The invention may be adapted for use on other kinds of motorized vehicles, or to any application where loads supplied by a DC power source require remote control, including but not limited to automotive (cars and trucks), aeronautic (planes and helicopters), maritime (power boats and motorized sailboats), locomotive (trains and trolleys), and construction (elevators and heating, ventilation and air-conditioning (HVAC)) applications.

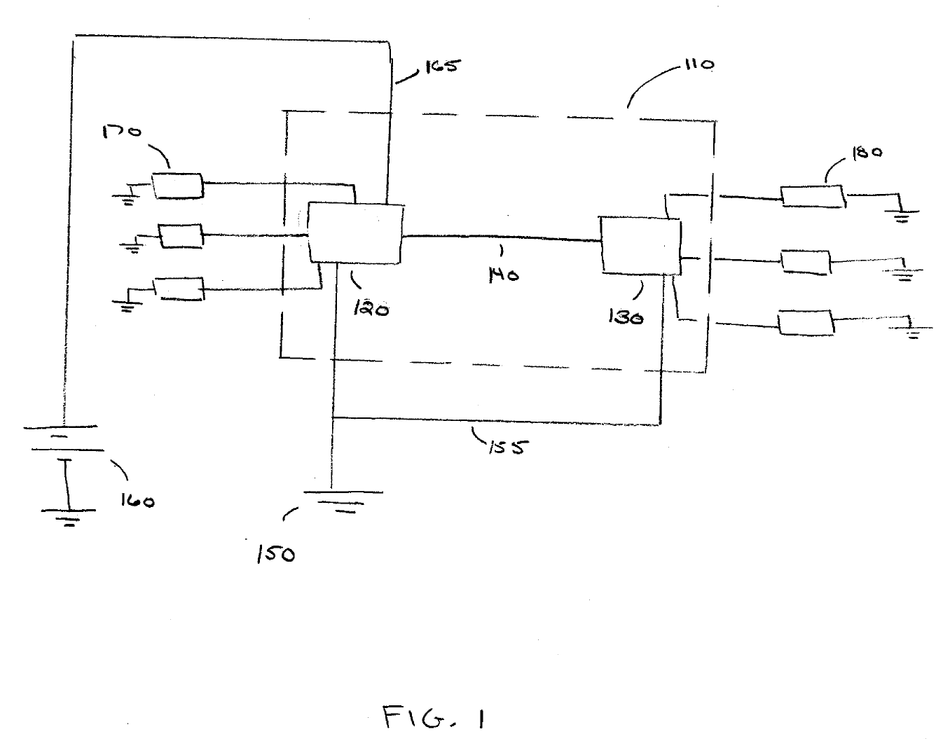

A block diagram of a preferred embodiment of a single conductor communication system is generally shown in FIG. 1. Single conductor communication system 110 includes a primary control module 120 and a secondary control module 130 connected by a main conductor 140. Main conductor 140 is a single wire that carries both power and communication signals. Primary control module 120 and secondary control module 130 each connect to a common ground connection 150 by ground conductors 155. Primary control module 120 is connected to power source 160 by power connector 165. Primary control module 120 is further connected to one or more primary devices 170. Secondary control module 130 is connected to one or more secondary devices 180. Power source 160 provides power for the loads applied by primary devices 170 and secondary devices 180. Although not shown in FIG. 1, alternate embodiments may include additional control modules, such that secondary control module 130 may connect to a third control module, and the third control module could connect to a fourth control module, and so on. In another embodiment, the output of secondary control module 130 may be connected to a load (not shown) that returns current through ground connection 150.

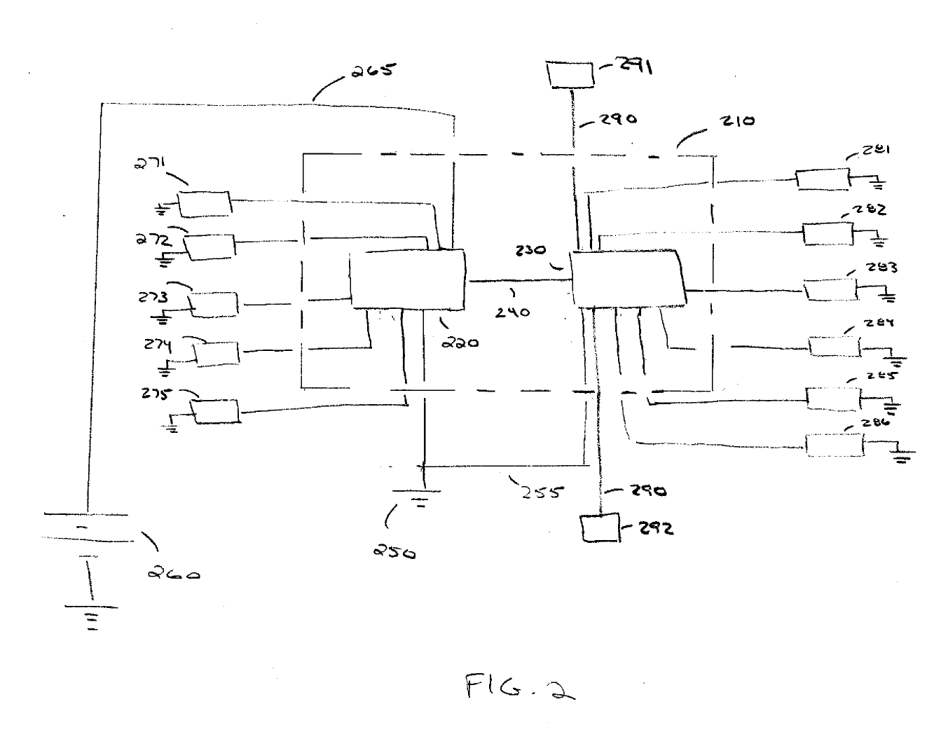

Referring to FIG. 2, a block diagram of a preferred embodiment of a single conductor communication system of the present invention is generally shown applied to a motorcycle. Single conductor communication system 210 includes rear control box 220 and front control box 230. Rear control box 220 is the primary control module, and front control box 230 is the secondary control module. Rear control box 220 and front control box 230 are preferably constructed of plastic or aluminum, but other materials, including but not limited to wood, brass, and stainless steel are contemplated and within the scope of the invention. Rear control box 220 is preferably attached to the motorcycle near the battery and front control box 230 is preferably attached to the motorcycle at the handlebars or in the headlight. Rear control box 220 and front control box 230 are preferably attached to the motorcycle by the use of adhesive tape, although other methods of attachment, including but not limited to glue, cable ties, and other fasteners known in the art are contemplated and within the scope of the invention.

With further reference to FIG. 2, rear control box 220 has a height preferably in the range of approximately 0.5 inches (about 1.27 centimeters) through approximately 1 inch (about 2.54 centimeters), although in other embodiments, rear control box 220 can have a height as small as approximately 0.25 inches (about 0.635 centimeters) or as large as necessary for the application. Rear control box 220 has a width preferably in the range of approximately 1.5 inches (about 2.31 centimeters) through approximately 2 inches (about 5.08 centimeters), although in other embodiments, rear control box 220 can have a width as small as approximately 1 inch (about 2.54 centimeters) or as large as necessary for the application. Rear control box 220 has a depth preferably in the range of approximately 1.5 inches (about 2.31 centimeters) through approximately 2 inches (about 5.08 centimeters), although in other embodiments, rear control box 220 can have a depth as small as approximately 1 inch (about 2.54 centimeters) or as large as necessary for the application.

With further reference to FIG. 2, front control box 230 has a height preferably in the range of approximately 0.5 inches (about 1.27 centimeters) through approximately 1 inch (about 2.54 centimeters), although in other embodiments, front control box 230 can have a height as small as approximately 0.25 inches (about 0.635 centimeters) or as large as necessary for the application. Front control box 230 has a width preferably in the range of approximately 1.5 inches (about 2.31 centimeters) through approximately 2 inches (about 5.08 centimeters), although in other embodiments, front control box 230 can have a width as small as approximately 1 inch (about 2.54 centimeters) or as large as necessary for the application. Front control box 230 has a depth preferably in the range of approximately 1.5 inches (about 2.31 centimeters) through approximately 2 inches (about 5.08 centimeters), although in other embodiments, front control box 230 can have a depth as small as approximately 1 inch (about 2.54 centimeters) or as large as necessary for the application.

With further reference to FIG. 2, rear control box 220 and front control box 230 are connected by main conductor 240. Main conductor 240 is a single wire that carries both power and communication signals. The use of a single wire between the control boxes may eliminate or reduce the problems associated with installation, minimizing the time required to install a wiring system by as much as half, and may decrease the possibility of wiring errors. In addition, the use of a single wire may simplify troubleshooting, repair and maintenance tasks. Further, by having only one wire running along the frame of the motorcycle, the need for a frame or sleeve may be eliminated, and the overall appearance of the motorcycle may be improved.

Main conductor 240 is preferably a single 12 American Wire Gauge (awg) stranded electrical wire, although other sizes and types of wires appropriate for the current load and mechanical-wear requirements of the design are contemplated and within the scope of the invention. Main conductor 240 is preferably a high-temperature, thermosetting wire that is resistant to abrasion, cutting, impact, and solvents, which may further improve the reliability of single conductor communication system 210.

With further reference to FIG. 2, rear control box 220 and front control box 230 each connect to a common ground connection 250 by ground conductors 255. Preferably, ground connection 250 is the motorcycle frame, although other ground connections, including but not limited to a wire or common conductive structure are contemplated and within the scope of the invention. Rear control box 220 is connected to power source 260 by power connector 265. Preferably, power source 260 is a 12 V motorcycle battery, although other power sources, including but not limited to any DC power supply having a voltage range from approximately 5V to approximately 100V are contemplated and within the scope of the invention. Ground conductor 255 is preferably a 16 awg stranded electrical wire, although other sizes and types of wires are contemplated and within the scope of the invention.

With further reference to FIG. 2, rear control module 220 is also connected to one or more rear devices. Rear devices may include rear left signal 271, brake signal 272, running lights 273, rear right signal 274, and horn 275. This list is not limiting, and additional or alternate rear devices, such as a license plate illuminating light (not shown) are contemplated and within the scope of the invention. Front control box 230 is connected to one or more front devices. Front devices may include front left signal 281, running lights 282 and 283, high beam headlight 284, low beam headlight 285, and front right signal 286. This list is not limiting, and additional or alternate front devices, such as a fog light (not shown) are contemplated and within the scope of the invention.

With further reference to FIG. 2, handlebar conductor 290 connects front control box 230 to left handlebar pod 291 and right handlebar pod 292. Handlebar conductor 290 is preferably a single wire 18 awg stranded electrical wire, although other sizes and types of wires, including but not limited to 00 awg through 40 awg are contemplated and within the scope of the invention. While not required, handlebar conductor 290 may be a high-temperature, thermosetting wire that is resistant to abrasion, cutting, impact, and solvents.

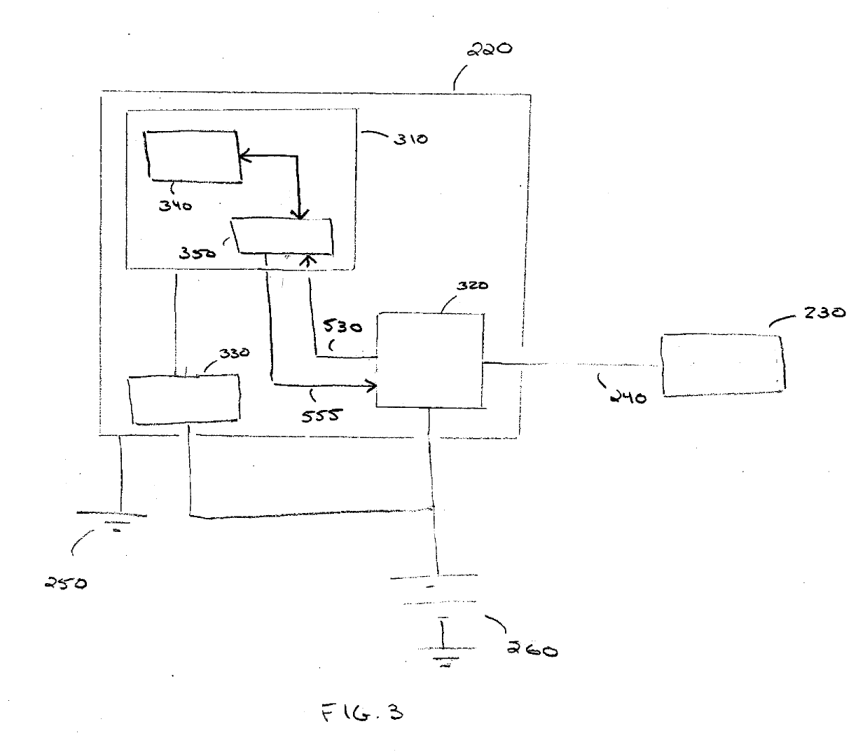

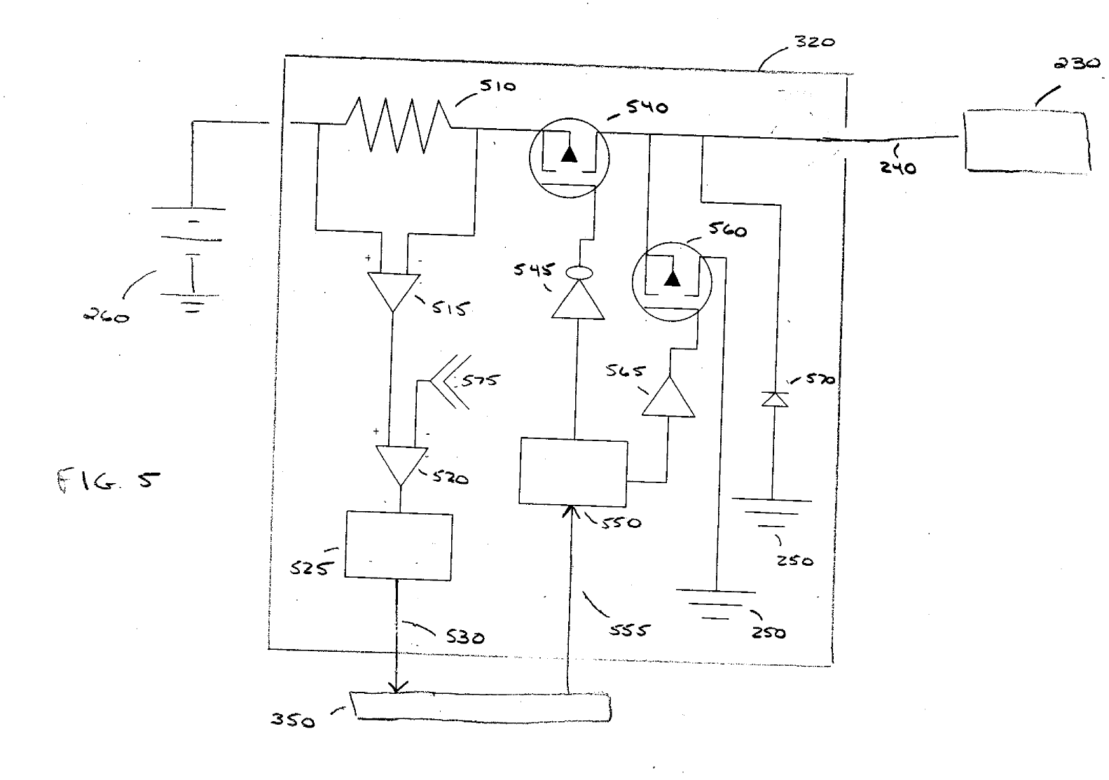

Referring to FIG. 3, a block diagram of a preferred embodiment of a rear control box of the present invention is generally shown. Rear control box 220 includes a microprocessor 310, communication circuitry 320, and a low-voltage regulator 330. Main conductor 240 carries DC power and communication signals between rear control box 220 and front control box 230. A preferred embodiment of communications circuitry 320 is shown generally in FIG. 5.

Microprocessor 310 is preferably a PIC 16 F Series Microprocessor from Microchip Semiconductor Corporation, although other microprocessors that include an embedded UART (Universal Asynchronous Receiver Transmitter) module, or that can be supplemented with a UART module or other circuitry that can generate a logical “1” and a logical “0,” are contemplated and within the scope of the invention. Microprocessor 310 receives DC power from power source 260 that has been conditioned by low-voltage regulator 330. Microprocessor 310 includes a microprocessor core 340 and a communication module 350. Microprocessor core 340 performs functions well known in the art, including but not limited to executing code, managing data, and controlling outputs. Communication module 350 preferably includes an AUSART (Addressable Universal Synchronous Asynchronous Receiver Transmitter) module (not shown) and performs functions well known in the art, including but not limited to serializing data and detecting simple communication errors. The AUSART is preferred because it can support addressing, which provides additional flexibility when defining a communication protocol.

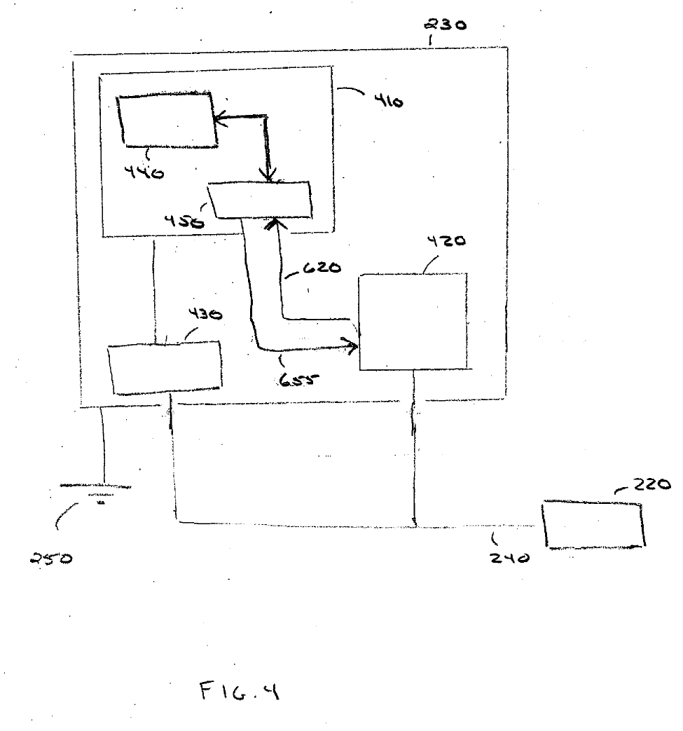

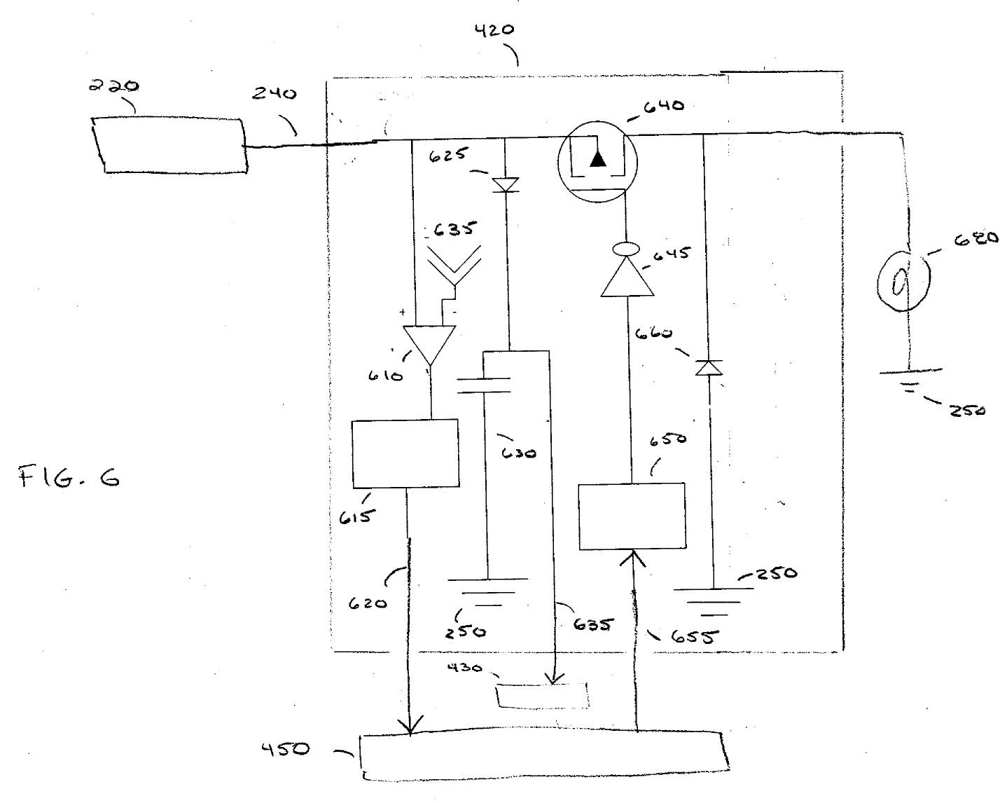

Referring to FIG. 4, a block diagram of a preferred embodiment of a front control box of the present invention is generally shown. Front control box 230 includes a microprocessor 410, communication circuitry 420, and a low-voltage regulator 430. Main conductor 240 carries DC power and communication signals between rear control box 220 and front control box 230. A preferred embodiment of communications circuitry 420 is shown generally in FIG. 6.

Microprocessor 410 is preferably a PIC 16 F Series Microprocessor from Microchip Semiconductor Corporation, although other microprocessors that include an embedded UART (Universal Asynchronous Receiver Transmitter) module, or that can be supplemented with a UART module or other circuitry that can generate a logical “1” and a logical “0,” are contemplated and within the scope of the invention. Microprocessor 410 receives DC power from rear control box 220 that has been conditioned by low-voltage regulator 430. Microprocessor 410 includes a microprocessor core 440 and a communication module 450. Microprocessor core 440 performs functions well known in the art, including but not limited to executing code, managing data, and controlling outputs. Communication module 450 preferably includes an AUSART (Addressable Universal Synchronous Asynchronous Receiver Transmitter) module (not shown) and performs functions well known in the art, including but not limited to that serializing data and detecting simple communication errors. The AUSART is preferred because it can support addressing, which provides additional flexibility when defining a communication protocol.

With further reference to FIGS. 3 and 4, microprocessors 310 and 410 may be programmed to perform system-monitoring functions. For example, a temperature sensor (not shown) in rear control box 220 may be used to protect electrical components by ensuring the operating environment does not exceed predetermined temperature limits. Temperature sensing may be particularly useful in a motorcycle application, where rear control box 220 may be located close to the engine.

Microprocessors 310 and 410 may also perform circuit-monitoring functions. For example, main output switching circuits in communications circuitry 320 and 420 may generate analog signals proportional to the output currents and voltages, which may be read by microprocessors 310 and 410 using conventional analog-to-digital converter architecture. In the preferred embodiment, all analog interface circuitry, with the exception of the signal multiplexer is contained within microprocessors 310 and 410.

Microprocessors 310 and 410 may also be programmed to detect error conditions, which may then be stored for debugging and diagnostics functions. Upon detection of a critical error, such as a short circuit that could significantly reduce system voltage, microprocessors 310 and 410 may be programmed to initiate a sequence of steps to minimize the effect of the critical error. In the case of a short circuit, for example, microprocessors 310 and 410 may be programmed to turn the system off before the system voltage significantly degrades.

In addition, microprocessors 310 and 410 may be programmed to perform security functions, such as disabling the motorcycle's ignition system. Microprocessors 310 and 410 may also include surge protection circuitry (not shown) to protect the electronic components from damaging signal spikes. In addition, microprocessors 310 and 410 may be programmed to provide customizable blinker canceling sequences, alarm functions, and safety start options. These additional features may be configured using a diagnostics module (not shown) and any computer or handheld device configured with a serial or USB (Universal Serial Bus) interface.

With further reference to FIGS. 3 and 4, the present invention provides a multiple-master communication system, in which any one microprocessor may initiate communication asynchronous to and independently of, any other microprocessor. The present invention preferably provides half-duplex data transmission, where data is transferred in both directions, but not simultaneously. In the preferred embodiment, microprocessor 310 in rear controller 220 and microprocessor 410 in front controller 230 alternate transmissions. In an alternate embodiment, the present invention may provide full-duplex transmissions from microprocessors 310 and 410, where data may be transferred simultaneously in both directions.

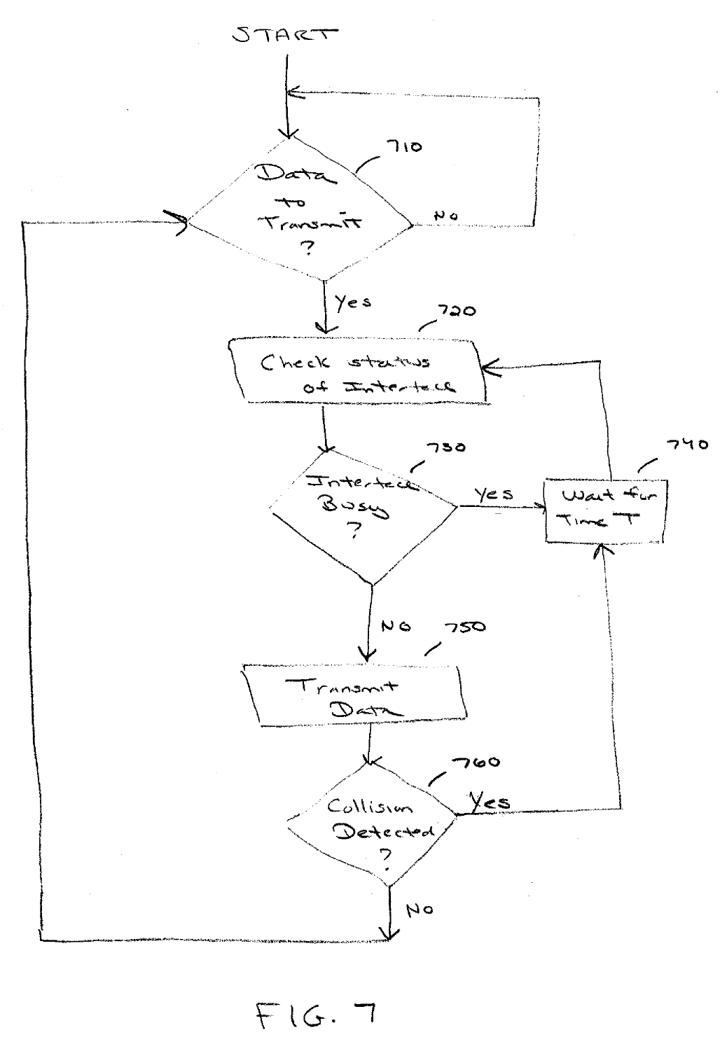

Referring to FIG. 7, a flow chart of the preferred embodiment of the half-duplex transmissions of microprocessors 310 and 410 is generally shown. Both microprocessors 310 and 410 execute the same steps. As shown at step 710, microprocessors 310 and 410 first determine if there is data to transmit between rear control box 220 and front control box 230. If so, before a communication can occur, microprocessors 310 and 410 must determine whether the interface is busy, i.e., whether a communication is already in progress, as shown in step 720. The status of the interface is preferably determined by checking the status of a bit within the AUSART module. This bit is preferably set when a communication begins. If the interface is busy, as shown in step 730, microprocessors 310 and 410 wait for a predetermined time period before again checking the status of the interface, as shown in step 740. To minimize collisions, each microprocessor preferably has a different time-out period. In the preferred embodiment, microprocessor 310 in rear control box 220 has a time-out period of approximately 10 ms, and microprocessor 410 in front control box 230 has a time-out period of approximately 20 ms. The longer time-out period for microprocessor 410 gives priority to microprocessor 310 in rear control box 220, while still providing sufficient time for microprocessor 410 in front control box 230 to transmit data without detectable latency.

However, despite the status check and the time-outs, it is still possible to have a collision on the interface because microprocessors 310 and 410 must execute one or more code cycles before an actual transmission can occur. Microprocessors 310 and 410 therefore detect whether a collision has occurred, as shown in step 760, preferably by determining if a framing error has occurred. If a collision is detected, as shown in step 760, microprocessors 310 and 410 wait for their respective predetermined time periods before again checking the status of the interface, as shown in step 740.

Communications between rear control box 220 and front control box 230 are supported by communications circuitry 220 and 230, as shown in FIGS. 5 and 6. The use of MOSFET circuit technology within communications circuitry 220 and 230 provides the high switching rates and high power levels that are necessary to transmit power and data over a single wire conductor. One other attribute of MOSFETs is that they can handle extremely high surge currents, in some cases over 200 A. This attribute enables the circuits of the present invention to be tolerant of even the most extreme short circuits. As stated above, the present invention may include shutting off the output if current exceeds a predetermined value. This protection is similar to that provided by a fuse, but since the current-monitoring is handled by the circuitry, the output is disabled much faster, possibly as much as ten times faster, than a fuse can open.

Referring to FIG. 5, a schematic diagram of a preferred embodiment of the communications circuitry of rear control box 220 is generally shown. Communications circuitry 320 includes a serial resistor 510, an amplifier 515, a level converter 520, a decoder 525, a first power MOSFET 540, a first high current gate driver 545, an encoder 550, a second power MOSFET 560, a second high current gate driver 565, an ultra-fast flyback diode 570, and a reference voltage 575.

In operation, to transmit data to, and receive data from, front control box 230, microprocessor 310 in rear control box 220 communicates with communication circuitry 320 through communication module 350. When microprocessor 310 in rear control box 220 decides to transmit data to front control box 230, a bit stream is sent via conductor 555 to encoder 550. Encoder 550 converts the bit stream from microprocessor 3 10 into a series of voltage pulses, which then turns MOSFETs 540 and 560 on and off. MOSFETs 540 and 560 are on when a voltage pulse is high or logical “1,” and off when a voltage pulse is low or logical “0.”

When microprocessor 410 in front control box 230 decides to transmit data to rear control box 220, rear control box 220 receives a group of current pulses. Series resistor 510 in rear control box communications circuitry 320 converts the current pulses into a differential voltage, which is amplified by amplifier 515 and then digitized by level converter 520 using reference voltage 575 to distinguish between a logical “1” and a logical “0.” The current pulses have now been converted to digital pulses, and are decoded by decoder 525. Decoder 525 sends the decoded bit stream to communication module 350 via conductor 530.

With further reference to FIG. 5, series resistor 510 is coupled to power source 260. Series resistor 510 is preferably 0.02 ohms. For a high current implementation, the minimum recommended resistance for series resistor 510 is approximately 0.01 ohms. For a low current implementation, the minimum recommended resistance for series resistor 510 is approximately 1.0 ohms. Because efficiency is reduced as resistance increases, a lower resistance is recommended, and is preferably calculated using Ohms law to create between a 0.1V and 0.5V drop across the output driver circuit, as measured across serial resistor 510 and first power MOSFET 540. The use of a low resistance series resistor 510 may also minimize the effects of electrical noise and line capacitance.

The use of low resistance series resistor 510 to minimize power and heat dissipation necessarily results in a small voltage drop across series resistor 510. Therefore, amplifier 515 is preferably used to amplify the voltage drop across series resistor 510 such that changes in the voltage can be reliably detected.

With further reference to FIG. 5, first power MOSFET 540 and second power MOSFET 560 provide the high current, at high transition rates, that are required to accomplish data communications with front control box 230 over conductor 240. Second power MOSFET 560 is used to improve the efficiency of the communications between front control box 230 and rear control box 220, because it permits a direct connection to ground when first power MOSFET 540 is turned off. This creates a hard connection to ground, which clamps the inductive energy from the high currents being transferred through main conductor 240 and dissipates the electrical charge that would be stored on a long length of wire in a DC system. As a result, the observed high-low (logical “1” to logical “0”) transition rate at front control box 230 is greatly increased, and the speed of the interface is also greatly increased. Ultra-fast flyback diode 570 is used to clamp the inductive energy for a few nanoseconds while MOSFETs 540 and 560 transitions from off to on, because a MOSFET cannot be instantaneously turned on or off.

MOSFETs 540 and 560 are preferably N-channel MOSFETs with gate overdrive, especially for higher current applications requiring greater than 1 amp. P-channel MOSFETs however, are also contemplated and within the scope of the invention. First power MOSFET 540 and second power MOSFET 560 are large components that require strong drive signals to switch on and off quickly. Because conventional microprocessors typically cannot provide the required drive signals, high current gate drivers 545 and 565 are used to increase the drive current to MOSFETs 540 and 560. Preferably, to minimize power consumption, first high current gate driver 545 is inverting, and second high current gate driver 565 is non-inverting.

When first power MOSFET 540 is switched off, second power MOSFET 560 almost immediately switches on. Preferably, encoder 550 controls the sequencing, and ensures that MOSFETs 540 and 560 are never on at the same time, which would create a hard short circuit between the battery and the ground, and subsequently degrade the operation of the MOSFETs.

With further reference to FIG. 5, decoder 525 is preferably a Manchester Decoder, and encoder 550 is preferably a Manchester Encoder. Manchester encoding is a form of digital encoding in which data bits are represented by transitions. In the preferred embodiment, a logical “1” is represented by an edge that transitions from low to high, and a logical “0” is represented by an edge that transitions from high to low. As a result, only the edge of a transition must occur within a required time window. With Manchester encoding, the signal synchronizes itself, which minimizes the error rate and improves reliability.

Referring to FIG. 6, a schematic diagram of a preferred embodiment of the communications circuitry of front control box 230 is generally shown. Communications circuitry 420 includes a level converter 610, a decoder 615, an isolation diode 625, a storage capacitor 630, a reference voltage 635, a power MOSFET 640, a high current gate driver 645, an encoder 650, and an ultra-fast flyback diode 660. Microprocessor 410 communicates with communication circuitry 420 through communication module 450.

When microprocessor 310 in rear control box 220 decides to transmit data to front control box 230, front control box 230 receives a group of voltage pulses. Front control box microprocessor 410 must be isolated from these drops in supply voltage or it will be reset each time the supply voltage drops to “0.” This function is performed by isolation diode 625 and capacitor 630. Isolation diode 625 allows current to flow into capacitor 630 when voltage is present on main conductor 240. Capacitor 630 maintains a continuous voltage to microprocessor 410 through conductor 635 even when there is no voltage on main conductor 240. Capacitor 630 should be chosen such that the current draw from microprocessor 410 and other circuitry of front control box 230 does not reduce the voltage below the operating voltage of microprocessor 410. In the preferred embodiment, the current required to support microprocessor 410 and other circuitry of front control box 230 is approximately 45 mA and a 10 μF capacitor is used.

Voltage pulses from rear control box 220 are digitized by level converter 610 using reference voltage 635 to distinguish between a logical “1” and a logical “0.” The digitized voltage pulses are then decoded by decoder 615, which sends the decoded bit stream to communication module 450 via conductor 620. Decoder 615 is preferably a Manchester Decoder and encoder 650 is preferably a Manchester Encoder.

When microprocessor 410 in front control box 230 decides to transmit data to rear control box 220, a bit stream is sent via conductor 655 to encoder 650. Encoder 650 converts the bit stream from microprocessor 410 into a serious of voltage pulses, which then turns MOSFET 640 on and off. MOSFET 640 is on when a voltage pulse is high or logical “1,” and off when a voltage pulse is low or logical “0.” While the voltage to load 680 is being switched, the current supplied to high current load 680 is also being switched, which results in a series of current pulses being sent to rear control box 220 over main conductor 240. High current load 680 preferably draws a current of 0.1 A or more, although in other embodiments current may range from 50 mA to 100 A. Ultra-fast flyback diode 660 conducts current while clamping the inductive energy stored on main conductor 240 and load 680 during the brief period of time that MOSFET 640 is switched off, when a logical “0” is sent to rear control box 220. In other embodiments, where the system has a large inductive load (greater than 100 nH), a second MOSFET (not shown) connected to ground may be necessary in conjunction with diode 660 to clamp the load when it is switched off, similar to the design of communications circuitry 320 in rear control box 220.

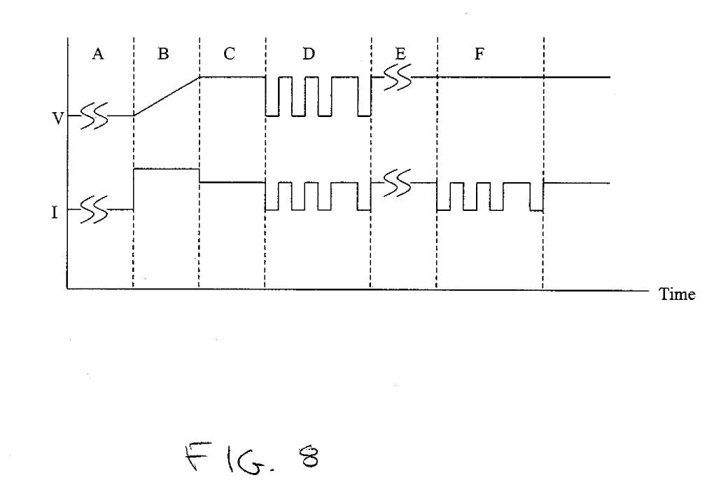

Referring to FIG. 8, an exemplary graph of the voltage and current pulses transmitted over main conductor 240 from the perspective of the rear control box 220 is generally shown. In block “A,” there is no power on main conductor 240.

In block “B,” rear control box 220 linearly ramps up the output voltage, which slowly charges capacitor 630 in front control box 230. This slow voltage ramp up is less damaging to the system as a whole, and helps to mitigate the effects of inrush currents in a light bulb used as a load 680 by front control box 230. An inrush current occurs when a light bulb filament is cold and has very low resistance. As voltage is applied, the filament begins to heat up. Before it completely heats up, however, the filament can draw a large amount of current, often a much as five to ten times its rated operating current. This high current can be damaging to the system, and thus minimizing it, by slowing ramping up the voltage, is desirable. The startup time should be based upon the thermal dissipation capabilities of MOSFET 540 and on the maximum output current of the system. In the preferred embodiment, the startup time is very fast, on the order of 100 μs.

As shown in block “B,” in the absence of a short circuit, the current during the voltage ramp up is approximately constant at a level necessary to charge capacitor 630 in front control box 230, according to the equation I=C(Dv/dt), where I is the current, C is the total capacitance, and Dv/dt is the ramp rate in volts/second. However, if a light bulb is used as the load 680 by front control box 230, there will be a spike in the current at the voltage threshold where MOSFET 640 turns on, attributable to the inrush current in the light bulb. This threshold voltage is approximately 6V. If there is a short circuit during the ramp up period, the current will ramp linearly with the voltage. This may be detected, however, by microprocessor 310, which may shut off the voltage output.

Block “C” depicts a wait time during which startup code is executed in microprocessors 310 and 410. This wait time also permits the filament in a light bulb used as a load 680 to reach equilibrium at its lowest nominal operating current. In the preferred embodiment, this wait time is approximately 100 ms.

Block “D” depicts a communication from rear control box 220 to front control box 230. As described, rear control box 220 switches the output voltage on and off, creating a chain of voltage pulses. Although current sensing circuitry in rear control box 220 sees this communication to front control box 230 (knows as data mirroring), microprocessor 310 may be programmed to ignore it. Front control box 230 sees only the voltage pulses, and decodes the date for its own internal functioning, as described above.

Block “E” depicts no communication between front control box 230 and rear control box 220. During this time the voltage and current values are constant.

Block “F” depicts a communication from front control box 230 to rear control box 220. Rear control box 220 sees this communication as a chain of current pulses, while the voltage remains constant. Rear control box 220 decodes the data for its own internal functioning, as described above.

The present invention, as described above, can provide high power levels to the secondary control module 130 or front control box 230, at least in part because the circuitry of the present invention is more efficient than the prior art at higher power levels. The present invention may have an efficiency of between 95% and 100% up to a theoretically unlimited power level, although it is limited in practice at least in part by high power radio frequency (RF) noise. Specifically, the present invention supports currents in the range of approximately 50 mA to approximately 100 A, as compared to a range of 25 mA for 40 mA in the prior art. In addition, while the prior art is limited to a voltage range of 2.5V to 6V, the present invention supports voltages in the range of 2.5V to 100V, dependent at least in part on the choice of components.

The present invention supports baud rates of approximately 33,600 to approximately 62,500 bits per second, compared to a maximum baud rate of 14,400 bits per second in the prior art. The prior art is limited because of the high output impedance of the prior art architecture, while the present invention has a much lower output impedance.

Although specific features of the invention are shown in some figures and not others, this is for convenience only, as some features may be combined with any or all of the other features in accordance with the invention.

Recitation ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A system for commanding and monitoring the status of a plurality of electrical devices disposed throughout an apparatus, comprising:
a single wire conductor for bi-directional transmission of voltage signals in a first direction and current signals in a second direction;
two or more controllers disposed throughout the apparatus, each controller connected to the conductor, and each controller further connected to a common reference connection;
wherein one of the controllers is connected to a direct current power supply and transmits voltage signals over the conductor;
wherein each of the other controllers is connected to at least one of the plurality of electrical devices and transmit current signals over the conductor; and
wherein said current signals and said voltage signals are used to affect said plurality of electrical devices.

2. An electronic module comprising:
an interface for bi-directionally communicating with at least a second electronic module via a single wire conductor and a reference connection, said interface including at least one MOSFET;
an AUSART connected to the interface;
a microprocessor connected to the AUSART; and
wherein said electronic module is coupled to a DC power source.

3. An electronic module comprising:
an interface for bi-directionally communicating with at least a second electronic module via a single wire conductor and a reference connection, said interface including at least one MOSFET;
an AUSART connected to the interface;
a microprocessor connected to the AUSART; and
wherein said electronic module is coupled to a load that draws DC power.

4. A bi-directional communications circuit, comprising:
a connection to a single wire conductor;
a connection to a DC power source;
an encoder for encoding data transmitted over the conductor;
a decoder for decoding data received over the conductor; and
at least one MOSFET for transmitting voltage pulses over the single wire conductor to at least a second communications circuit.

5 . A bi-directional communications circuit, comprising:
a connection to a single wire conductor;
an encoder for encoding data transmitted over the conductor;
a decoder for decoding data received over the conductor; and
at least one MOSFET for transmitting current pulses over the single wire conductor to at least a second communications circuit.

6. A method for transmitting digital data messages and power, comprising:
providing a single wire conductor between at least two electronic modules;
monitoring voltage pulses transmitted from a first of the at least two electronic modules over the conductor and decoding said voltage pulses into digital data;
monitoring current pulses transmitted from a second of the at least two electronic modules over the conductor and decoding said current pulses into digital data; and
using said voltage pulses from the first electronic module to power at least the second electronic module.
